(19) United States
(12) Patent Application Publication
(10) Pub. No.: US 2015/0086206 A1
(43) Pub. Date: Mar. 26, 2015

(54) FIBER OPTIC SENSING SYSTEMS AND METHODS OF OPERATING THE SAME

(71) Applicant: US Seismic Systems, Inc., Chatsworth, CA (US)

(72) Inventors: Eric Lee Goldner, Valencia, CA (US); Agop Hygasov Cherbettchian, Santa Monica, CA (US); Eric Udd, Fairview, OR (US); Sophie Pierrette Laut, Woodland Hills, CA (US)

(21) Appl. No.: 14/114,288

(22) PCT Filed: May 3, 2013
(86) PCT No.: PCT/US2013/039498

§ 371 Date: Oct. 28, 2013

Related U.S. Application Data
(60) Provisional application No. 61/642,760, filed on May 4, 2012.

(51) Int. Cl. H04J 14/02

(52) U.S. Cl. CPC H04J 14/0205; H04J 14/0216
USPC 398/84; 398/83; 398/85

(57) ABSTRACT

A fiber optic sensing system. The fiber optic sensing system includes an optical source adapted to provide an optical signal at a plurality of wavelengths. The fiber optic sensing system also includes a plurality of wavelength taps for separating the optical signal into signal portions at each of the plurality of wavelengths. The fiber optic sensing system further includes a plurality of optical sensors, each of the optical sensors configured to receive one of the signal portions at a respective one of the plurality of wavelengths. The fiber optic sensing system still further includes a plurality of wavelength combiners for combining signal portions from the plurality of optical sensors into a recombined signal. Also included in the fiber optic sensing system is an optical receiver for receiving the recombined signal. The fiber optic sensing system also includes an optical fiber path between the optical source and the optical receiver.

### RELATED APPLICATION

This application claims the benefit of priority to U.S. Provisional Patent Application Ser. No. 61/642,760, filed on May 4, 2012, the contents of which are incorporated in this application by reference.

### TECHNICAL FIELD

The present invention relates generally to fiber optic sensing systems and, more particularly, to fiber optic sensing systems having particular applicability in high-temperature environments and methods of using the same.

### BACKGROUND OF THE INVENTION

Electronic geophone-based fiber optic sensing systems are well known in the art and have use in a number of applications. For example, fiber optic sensing systems and those including electronic geophones are used to image subsurface structures using vertical seismic profiling and microseismic events during operations such as hydrofracturing for the production of oil, natural gas, and geothermal energy (e.g., enhanced geothermal recovery). Traditional electronic and even some optical tools suffer, however, from the inability to withstand extended periods of time at elevated temperatures above 100° C.

Thus, it would be desirable to provide improved fiber optic sensing systems for use in applications with elevated temperatures.

### BRIEF SUMMARY OF THE INVENTION

According to an exemplary embodiment of the present invention, a fiber optic sensing system is provided. The fiber optic sensing system includes an optical source adapted to provide an optical signal at a plurality of wavelengths. The fiber optic sensing system also includes a plurality of wavelength taps for separating the optical signal into signal portions at each of the plurality of wavelengths. The fiber optic sensing system further includes a plurality of optical sensors, each of the optical sensors configured to receive one of the signal portions at a respective one of the plurality of wavelengths. The fiber optic sensing system still further includes a plurality of wavelength combiners for combining signal portions from the plurality of optical sensors (e.g., returned signal portions) into a recombined (e.g., multi-wavelength) signal. Also included in the fiber optic sensing system is an optical receiver (or a plurality of optical receivers) for receiving the recombined signal. One or more optical fiber paths are included in the fiber optic sensing system between the optical source and the optical receiver.

The optical receiver (which may be considered return optics) may include optics for separating the multi-wavelength signal received by the optical receiver into individual signals, each at a different wavelength. The optical receiver also may include signal processing for converting the individual signal portions into electronic signals proportional to the physical quantities measured at each of the sensors (e.g., acceleration, velocity, dynamic pressure changes, etc.).

According to another exemplary embodiment of the present invention, a method of operating a fiber optic sensing system is provided. The method includes the steps of: (a) transmitting an optical signal from an optical source such that the optical signal includes a plurality of wavelengths; (b) separating the optical signal into signal portions at each of the plurality of wavelengths using a plurality of wavelengths taps; (c) receiving ones of the signal portions at respective ones of a plurality of optical sensors; (d) combining signal portions from the plurality of optical sensors into a recombined signal using a plurality of wavelength combiners; and (e) receiving the recombined signal at an optical receiver.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a block diagram of a fiber optic sensing system in accordance with an exemplary embodiment of the present invention;

FIG. 2 is a block diagram of a fiber optic sensing system in a ladder style configuration in accordance with an exemplary embodiment of the present invention;

FIG. 3 is a block diagram of a multiplexed optical source in accordance with an exemplary embodiment of the present invention;

FIG. 4 is a block diagram of a Michelson interferometer sensor in accordance with an exemplary embodiment of the present invention;

FIG. 5 is a block diagram of a Mach-Zehnder interferometer sensor in accordance with an exemplary embodiment of the present invention;

FIG. 6 is a block diagram of a fiber optic accelerometer that may be used in a fiber optic sensing system in accordance with an exemplary embodiment of the present invention;

FIG. 7 is a block diagram of a multiplexing configuration of a fiber optic sensing system in accordance with an exemplary embodiment of the present invention;

FIG. 8 is a block diagram illustrating a three-sensor module of a fiber optic sensing system in accordance with an exemplary embodiment of the present invention;

FIG. 9 is a block diagram illustrating a three-axis module of a fiber optic sensing system in accordance with an exemplary embodiment of the present invention;

FIG. 10 is a block diagram illustrating an input signal and return signal wavelength division configuration in accordance with an exemplary embodiment of the present invention; and

FIGS. 11-13 are block diagrams illustrating various multiplexing configurations for fiber optic sensing systems in accordance with various exemplary embodiments of the present invention.

### DETAILED DESCRIPTION OF THE INVENTION

As will be explained in greater detail below, according to certain exemplary embodiments of the present invention, improved fiber optic sensing systems are provided that incorporate a sequence of wavelength taps to separate an optical signal into a plurality of signal portions (e.g., narrow line width output signal portions). For example, the wavelength taps are used to strip off individual wavelengths of an optical signal (e.g., wavelength division multiplexing), where each individual wavelength may be used for sensing in an optical sensor (e.g., to sense acceleration to which the optical sensor is subject) (e.g., where the optical sensor may include a fiber optic accelerometer, a transducer, etc.). In one specific example, the optical sensor may be a fiber optic hydrophone (e.g., including an optical fiber coated with a voided elastomer).

Multiple sensors may be included at each sensing location for sensing in different directions (e.g., along different axes). The optical signals transmitted to the individual sensors are then recombined using wavelength combiners, and the recombined signal is then transmitted back to the return optics (e.g., to an optical receiver) for demultiplexing into different wavelengths, and signal processing as is known to those skilled in the art. Exemplary wavelength taps and combiners include OADMs (i.e., optical add/drop multiplexers), slope filters, wavelength discriminators, wavelength demultiplexers, and Wavelength Division Multiplexers (WDMs). Various optical sensor configurations may be utilized including but not limited to Michelson interferometer optical sensors, Fabry-Perot interferometer optical sensors, Fiber Bragg Grating (FBG)-based optical sensors, Sagnac interferometer optical sensors, etc. Transducers may also be incorporated into the optical sensors. Exemplary transducers include: a fixed portion (e.g., a fixed mandrel) fixed to a body of interest; a moving portion (a moveable mandrel) that can move with respect to the fixed portion; a spring member disposed between the fixed portion and the moveable portion; and an optical fiber wrapped between the fixed portion and the moveable portion to sense strain in the optical fiber that is proportional to a measurable quantity (e.g., a physical quantity such as acceleration, pressure, etc.). This strain is converted to a change in phase of the light passing through the optical fiber. An interferometer which incorporates the transducer in the sensor converts the change in phase to a change in light/optical intensity. The signal representing this change in optical intensity may be converted to an electrical output signal (e.g., an analog signal, a digital signal) proportional to the original measurable quantity at the interrogation or signal processing electronics.

Certain aspects of the present invention provide for fiber optic sensing systems having particular applicability in high-temperature environments (e.g., where the optical sensors included in an optical sensor array may withstand extended periods of time at temperatures exceeding 200° C. without failing or experiencing performance degradation). The electronics (e.g., source optics including a multi-wavelength optical source, return optics, the interrogation system, etc.) may be desirably located remote from the optical sensors to increase the lifetime of the electronics, and to allow for repair or replacement of elements of the electronics without costly retrieval of the sensors from the remote environment being sensed (e.g., a borehole).

In accordance with certain exemplary embodiments of the present invention, a high-efficiency fiber optic accelerometer may be utilized that uses a fraction (˜10%) of the fiber in comparison to the conventional fiber optic accelerometers. This reduces the sensitivity to darkening of the fiber due to hydrogen ingress through a pressure housing that is common with other fiber optic sensors. For extreme environments, a pure silica core optical fiber can be used for the lead and connecting cables, and for the sensor fiber, to further reduce the sensitivity of the optical fiber sensor to hydrogen darkening.

In accordance with certain exemplary embodiments of the present invention, separate source and return optical fibers are used to minimize potential coherent Rayleigh backscatter noise as it is desirable that return optical signals from the sensors do not interfere with the optical source power. Noise due to coherent Rayleigh backscatter may be particularly problematic when low power optical returns from sensors interfere with high source optical power at locations in a lead cable (e.g., at the many locations where there are small changes in the refractive index of the fiber).

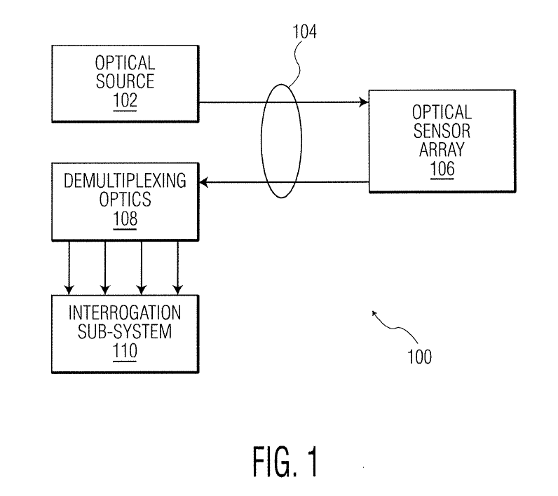

Referring now to the drawing, in which like reference numbers refer to like elements throughout the various figures that comprise the drawing, FIG. 1 illustrates a fiber optic sensing system 100 including an optical source 102 configured to provide an optical signal at a plurality of wavelengths. For example, optical source 102 may include light at wavelengths from a plurality of optical light sources (e.g., lasers, etc.) multiplexed onto one or more optical fibers within a fiber optic cable 104. The optical signal (including light at a plurality of wavelengths) is directed through an optical sensor array 106, where optical sensors in array 106 are designed to be supported by individual wavelengths included in the optical signal. Return signals from the sensors in array 106 are carried by optical fibers within fiber optic cable 104 that may be separate from (as shown in FIG. 1), or the same as, the optical fibers carrying the multiplexed optical signal from optical source 102. The return signals (e.g., in the form of a recombined signal) from the sensors in array 106 are separated from one another by wavelength demultiplexing optics 108 and are then directed toward one or more interrogation sub-system(s) 110. Interrogation sub-system 110 analyzes the return signals using conventional interrogation techniques.

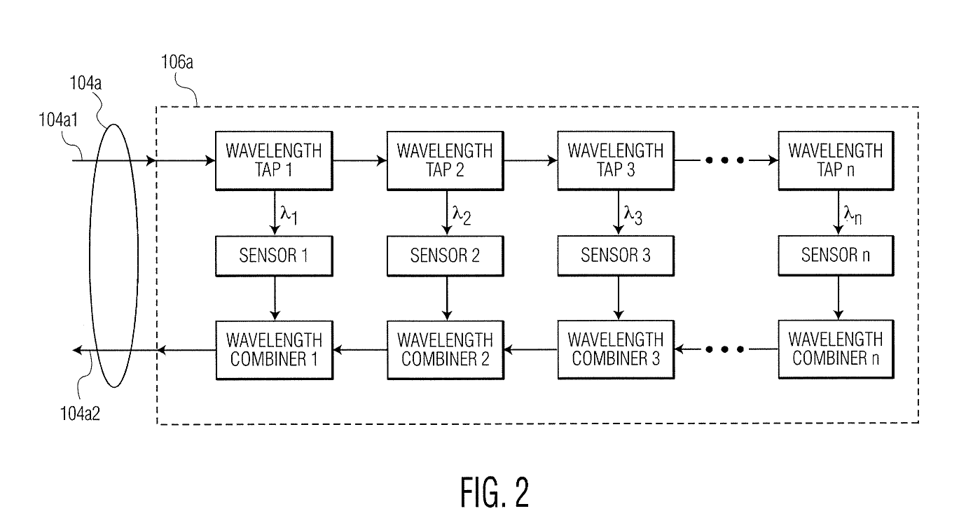

FIG. 2 illustrates an exemplary optical sensor array 106a. In FIG. 2, fiber optic cable 104a is an example of fiber optic cable 104 from FIG. 1, and optical sensor array 106a is an example of optical sensor array 106 from FIG. 1. The “ladder” style topology illustrated in FIG. 2 includes an input optical fiber 104a1 carrying an optical signal having “n” wavelengths. A plurality of wavelength taps (e.g., optical add/drop multiplexers, or OADMs) strip off individual wavelengths from the optical signal for transmission to respective optical sensors. More specifically, a first wavelength (λ₁) is stripped off the n-wavelength optical signal by a wavelength tap 1. This λ₁ signal is received by a sensor 1, and then the output signal from sensor 1 is recombined with the other output signals from the other sensors at a wavelength combiner 1.

A second wavelength (λ₂) is stripped off the λ₂-λₙ wavelength optical signal by a wavelength tap 2. This λ₂ signal is received by a sensor 2, and then the output signal from sensor 2 is recombined with other output signals from other sensors at a wavelength combiner 2. Likewise, a third wavelength (λ₃) is stripped off the λ₃-λₙ wavelength optical signal by wavelength tap 3. This λ₃ signal is received by a sensor 3, and then the output signal from sensor 3 is recombined with other output signals from other sensors at wavelength combiner 3.

This signal flow continues for each of the n wavelengths and corresponding optical sensors. Thus, the signal flow ends with a wavelength tap n sending the λₙ wavelength to a sensor n, which produces an output signal that is recombined with other output signals from other sensors at a wavelength combiner n. The complete recombined signal is transmitted along an output optical fiber 104a2 back to the return optics (e.g., wavelength demultiplexing optics and multiple interrogation sub-systems) for signal processing.

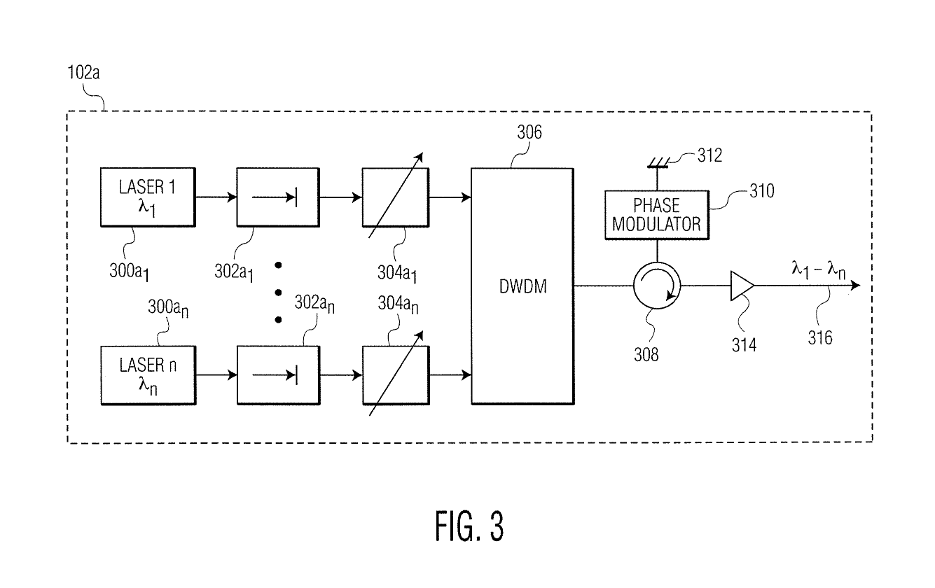

FIG. 3 is an example of an n-input wavelength optical source 102a. Optical source 102a is an example of optical source 102 from FIG. 1. The output from a light source 300a₁ (e.g., a laser light source at wavelength λ₁) is directed through an optical isolator 302a₁ to avoid noise and damage due to backscattered light. The output from optical isolator 302a₁ is then directed through a variable optical attenuator (VOA) 304a₁. Variable optical attenuator 304a₁ is used to balance the outputs of the system so that sensors have outputs that are more nearly matched when received at optical receivers within the interrogation sub-system 110.

Similarly, output light from each of the n light sources are directed through respective optical isolators and variable optical attenuators. The outputs from the n light sources (e.g., laser 1 through laser n), after transmission through respective optical isolators (302a₁ through 302aₙ) and variable optical attenuators (304a₁ through 304aₙ), are combined in a DWDM 306 (i.e., a dense wavelength division multiplexer DWDM, cascaded OADMs—one at each of the laser wavelengths, an arrayed waveguide device (AWG), or other multiplexing device), and may then be directed to a phase modulator 310 (after passing through an optical circulator 308). After being reflected by a reflector 312, the modulated signal (now including a phase encoded carrier signal) is boosted to a desired input power level by an optical amplifier 314. The now combined, modulated, and amplified, optical signal 316 (including wavelengths λ₁-λₙ) is ready for transmission to optical sensor array 106 as shown in FIG. 1.

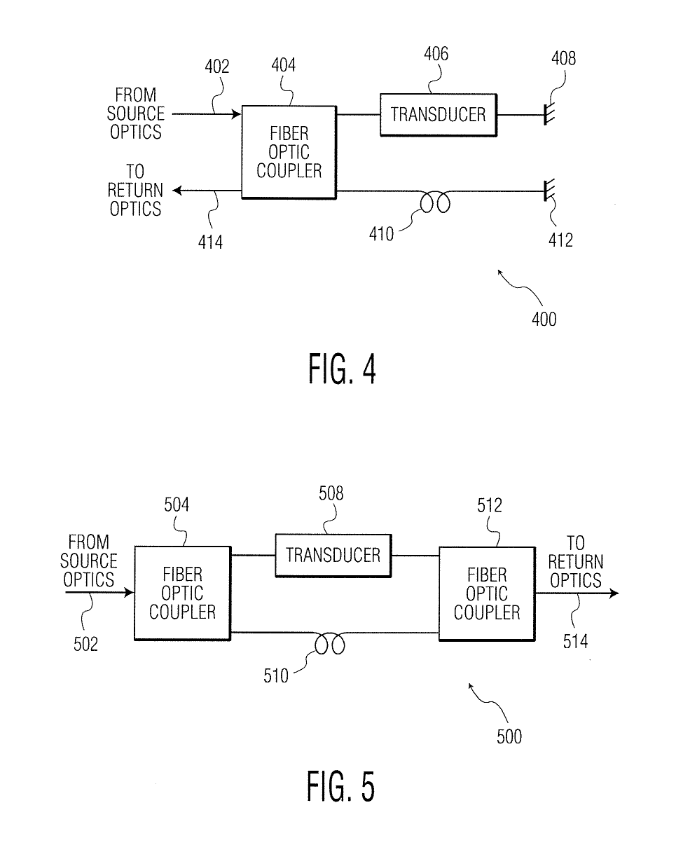

FIG. 4 illustrates a Michelson interferometer sensor 400. Such a sensor 400 is one of many possible configurations of sensors included in optical sensor array 106 shown in FIG. 1. An input light beam 402 (light at a specific wavelength stripped off the multi-wavelength optical signal from optical source 102 shown in FIG. 1) is split into two light beams at a fiber optic coupler 404. The first light beam passes through a fiber leg including a transducer 406 and terminating at a reflector 408. The second light beam passes through a fiber leg including a reference coil 410 and terminating at a reflector 412. Reflectors 408, 412 may be, for example, a mirror (e.g., a dielectric mirror, a metallic mirror, etc.), a fiber grating, a Faraday rotator mirror, etc. The optical signals that reflect back from respective reflectors 408, 412 are then directed back to fiber optic coupler 404, where the optical signals that are reflected back from reflectors 408, 412 are combined coherently to create a time-varying intensity proportional to the time-varying relative phase change between the two fiber legs. The output of fiber optic coupler 404 is then directed along an output optical fiber 414 to the return optics (i.e., not shown, but where the return optics include wavelength demultiplexing optics and an interrogation sub-system for analyzing the optical signals returned from sensor 400 and other sensors in the sensor array).

FIG. 5 is a diagram of a Mach-Zehnder interferometer sensor 500. Such a sensor 500 is one of many possible configurations that may be included in the sensors in optical sensor array 106 shown in FIG. 1. An input light beam 502 (light at a specific wavelength stripped off the multi-wavelength optical signal from optical source 102 shown in FIG. 1) is split into two light beams at a fiber optic coupler 504. The first light beam passes through a fiber leg including a transducer 508 and terminating at a fiber optic coupler 512. The second light beam passes through a fiber leg including a reference coil 510 and also terminating at fiber optic coupler 512. Thus, the two light beams are then recombined coherently at fiber optic coupler 512 to create a time-varying intensity proportional to the time-varying relative phase change between the two fiber legs. The output from fiber optic coupler 512 is then directed along an output optical fiber 514 to the return optics (i.e., not shown, but where the return optics include an interrogation sub-system for analyzing the optical signals returned from sensor 500 and other sensors in the sensor array).

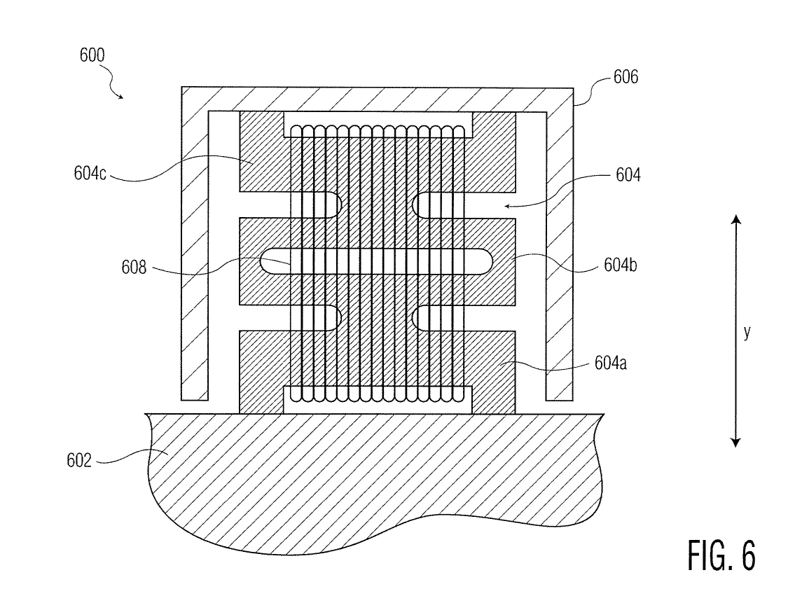

FIG. 6 is a cross-sectional view of a fiber optic accelerometer transducer 600. Such a transducer 600 may be included in a fiber optic sensor of an optical sensor array (such as array 106 shown in FIG. 1) to maximize the sensitivity of the sensor to linear acceleration in a particular direction. Transducer 600 includes a single-piece, machined spring assembly 604 and a moveable mass 606. Spring assembly 604 includes a fixed mandrel 604a, spring member 604b, and moveable mandrel 604c. Fixed mandrel 604a is attached to a body 602 of interest (e.g., a pressure-sealed vessel clamped to a borehole casing, etc.). A fiber 608 is continuous with (or connected to) an optical fiber included in the respective fiber optic sensor. Fiber 608 is coiled around spring assembly 604 such that, when coiled fiber 608 is subject to acceleration, spring assembly 604 causes fiber 608 to elongate and contract in coordination and in proportion to the received linear acceleration in direction y.

The optical path length change caused by this elongation and contraction may then be interferometrically compared to a fiber comprising a reference coil through the action of an interferometer (e.g., a Michelson interferometer, a Mach-Zehnder interferometer, etc.) associated with transducer 600 within a sensor, 400 or 500, for example. Output of such an interferometer may then be directed along an output optical fiber to the return optics (including an interrogation sub-system). Moveable mass 606 may be formed of a high-density material (e.g., brass, copper, tungsten, etc.) and is shaped to wrap around (or envelope) spring assembly 604, thereby providing a high mass value within a small volume to greatly increase the sensitivity of the transducer to acceleration. Transducer 600 is one example of a transducer that may be included in fiber optic sensors in accordance with the present invention. It is understood that alternative transducer configurations are contemplated. Transducers of the type illustrated in FIG. 6, as well as other exemplary configurations, are described in PCT Publication WO 2011/050227.

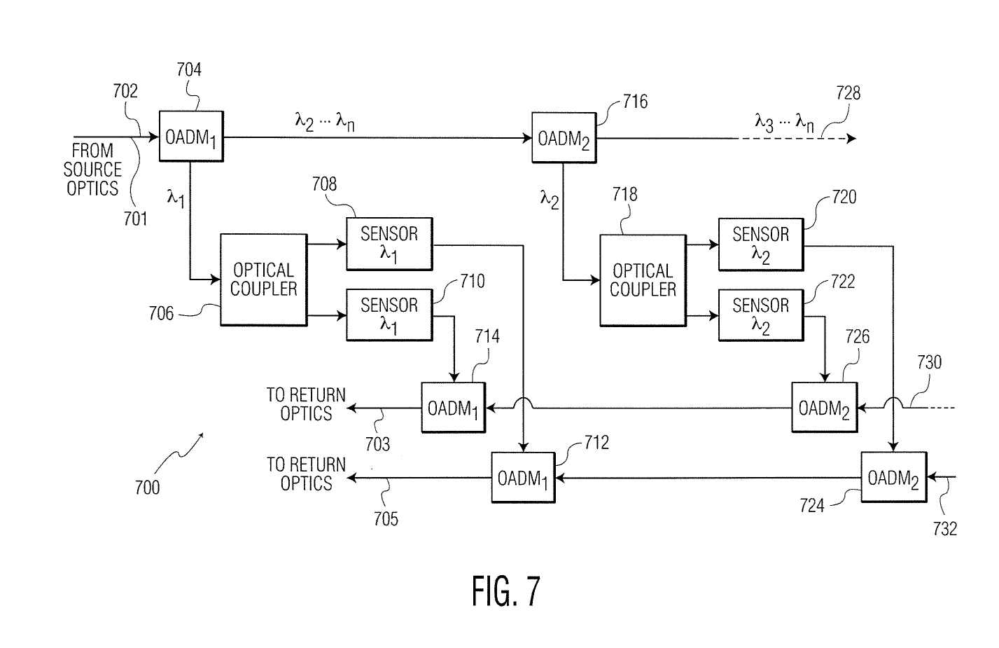

FIG. 7 illustrates elements of a fiber optic sensing system 700. In this exemplary configuration, a single input optical fiber 702 carries an input optical signal (including “n” wavelengths) transmitted from source optics of fiber optic sensing system 700. System 700 is configured to support “n” fiber optic sensors, one sensor for each of the “n” wavelengths. Each of the “n” wavelengths is divided/stripped off the input optical fiber by a wavelength tap (e.g., an OADM element). For example, an OADM₁ 704 strips wavelength 1 (λ₁) from the input optical signal. The optical signal carrying the remaining wavelengths (λ₂ . . . λₙ) is transmitted to an OADM₂ 716. Referring back to the wavelength 1 (λ₁) signal, this signal is divided by an optical coupler 706 (e.g., a 2×2 fused biconical taper coupler) and is directed toward two sensors (sensor 708 and sensor 710) at wavelength 1 (λ₁). The output signals from each of sensor 708 and sensor 710 are in turn directed along distinct optical fibers to respective ones of OADM₁ 714, 712 (i.e., wavelength combiners 714, 712).

OADM₂ 716 strips wavelength 2 (λ₂) from the optical signal, and the optical signal 728 carrying the remaining wavelengths (λ₃ . . . λₙ) is next transmitted to subsequent OADMs (not shown). Referring back to the wavelength 2 (λ₂) signal, this signal is divided by an optical coupler 718 (e.g., a 2×2 fused biconical taper coupler) and is directed toward two sensors (sensor 720 and sensor 722) at wavelength 2 (λ₂). The output signals from each of sensors 720, 722 are in turn directed along distinct optical fibers to respective ones of OADM₂ 726, 724 (i.e., wavelength combiners 726, 724). Each of wavelength combiners 726, 724 also receives another optical signal for recombining from a respective one of optical fibers 730, 732 (e.g., from downstream wavelength combiners, not shown). The combined output optical signal from OADM₂ 726 is combined with the output of sensor 710 at OADM₁ 714, and the output of OADM₁ 714 is transmitted along an optical fiber 703 to return optics of fiber optic sensing system 700. Similarly, the combined output optical signal from OADM₂ 724 is combined with the output of sensor 708 at OADM₁ 712, and the output of OADM₁ 712 is transmitted along an optical fiber 705 to return optics of fiber optic sensing system 700.

Although details of only two wavelengths are shown in FIG. 7, it is clear that such a configuration could be used to support many more wavelengths. In one specific example, this architecture could be used to support 12 laser wavelengths and 24 sensors. Further, this architecture may be extended to “n” lasers on one input optical fiber with 3n optical fibers out, supporting 3n sensors. In general, one input optical fiber in with n laser wavelengths can support Mn sensors with M output optical fibers.

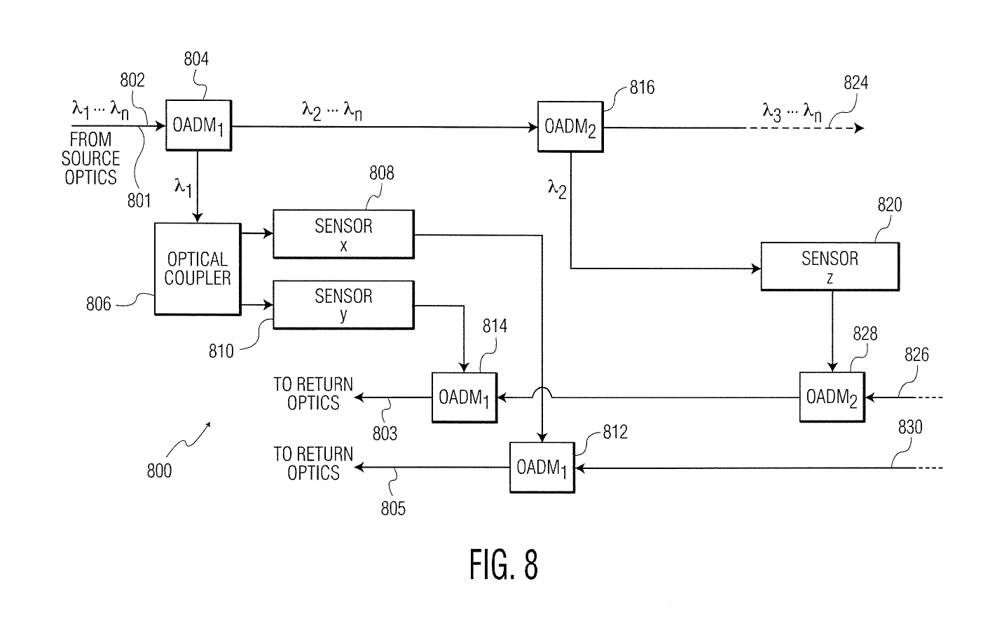

In certain fiber optic sensing applications, it may be desirable to provide sensors for sensing along multiple axes at a given location. For example, a module (e.g., a tri-axial accelerometer module) may be provided at such a location where the module houses sensors for sensing acceleration along each of an x-axis, y-axis, and z-axis. FIG. 8 illustrates such an arrangement including elements of a fiber optic sensing system 800. In this exemplary configuration, a single input optical fiber 802 carries an input optical signal (including “n” wavelengths) transmitted from source optics of fiber optic sensing system 800. In FIG. 8, an OADM₁ 804 strips wavelength 1 (λ₁) from the input optical signal. The optical signal carrying the remaining wavelengths (λ₂ . . . λₙ) is next transmitted to an OADM₂ 816. Referring back to the wavelength 1 (λ₁) signal, this signal is divided by an optical coupler 806 (e.g., a 2×2 beam splitter) and is directed toward two sensors 808, 810 (e.g., optical sensors 808, 810) for sensing acceleration along the x-axis and y-axis. The output signals from each of sensors 808, 810 are in turn directed along distinct optical fibers to respective ones of OADM₁ 814, 812 (i.e., wavelength combiners 814, 812).

OADM₂ 816 strips wavelength 2 (λ₂) from the optical signal, and the optical signal 824 carrying the remaining wavelengths (λ₃ . . . λₙ) is transmitted to subsequent OADMs (not shown). Referring back to the wavelength 2 (λ₂) signal, this signal is directed toward a sensor 820 for sensing acceleration along the z-axis at wavelength 2 (λ₂). The output signal from sensor 820 is directed to OADM₂ 828 (i.e., wavelength combiner 828). An OADM₂ 828 also receives another optical signal for recombining from an optical fiber 826 (e.g., from downstream wavelength combiners, not shown). The combined output optical signal from OADM₂ 828 is combined with the output of sensor 810 at OADM₁ 814, and the output of OADM₁ 814 is transmitted along an optical fiber 803 to return optics of fiber optic sensing system 800. Similarly, the optical signal transmitted from sensor 808 is combined with another optical signal from an optical fiber 830 at OADM₁ 812, and the output of OADM₁ 812 is transmitted along an optical fiber 805 to return optics of fiber optic sensing system 800.

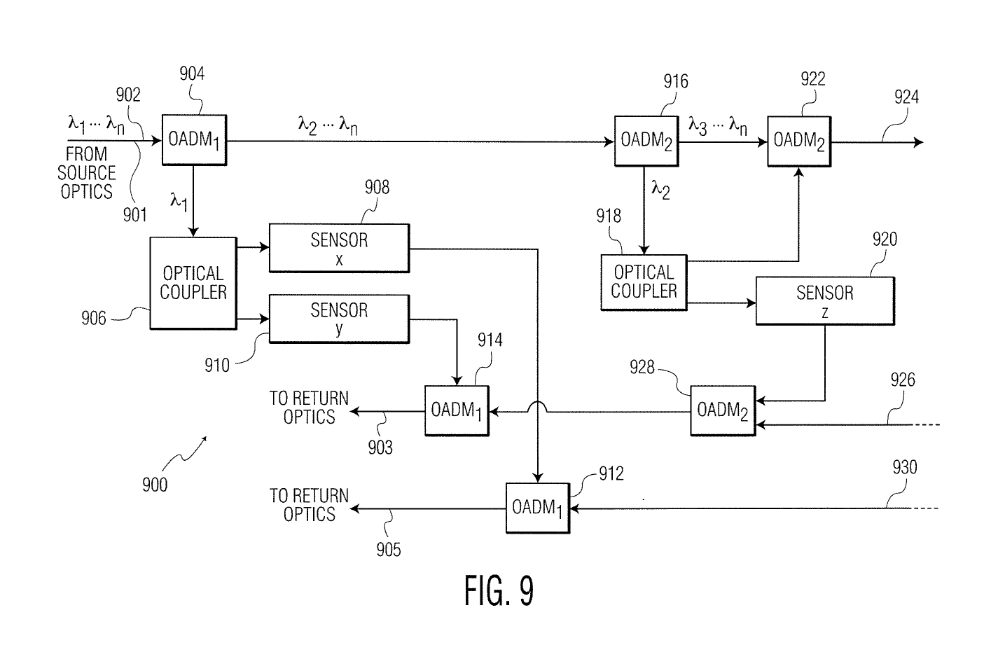

FIG. 9 illustrates elements of a fiber optic sensing system 900. Elements of system 900 having the same reference numerals as elements of system 800 shown in FIG. 8 (but with the first digit of such numerals being a “9” instead of “8”) are the same as those shown in, and described with respect to, FIG. 8. One difference of note between FIGS. 8 and 9 is that in FIG. 9 the output optical signal from OADM₂ 916 is split at an optical coupler 918 such that half of the light is transmitted to a sensor 920 (for sensing acceleration along the z-axis), while the other half of the light is recombined with the primary optical signal at an OADM₂ 922 such that this half of the light at wavelength 2 (λ₂) may be used in connection with sensing acceleration at a downstream sensor/interferometer.

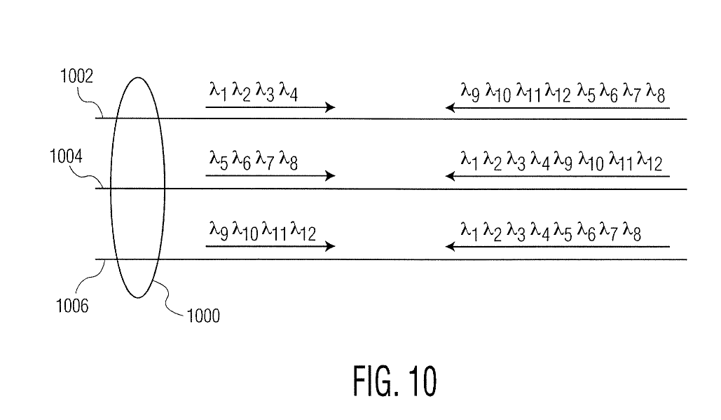

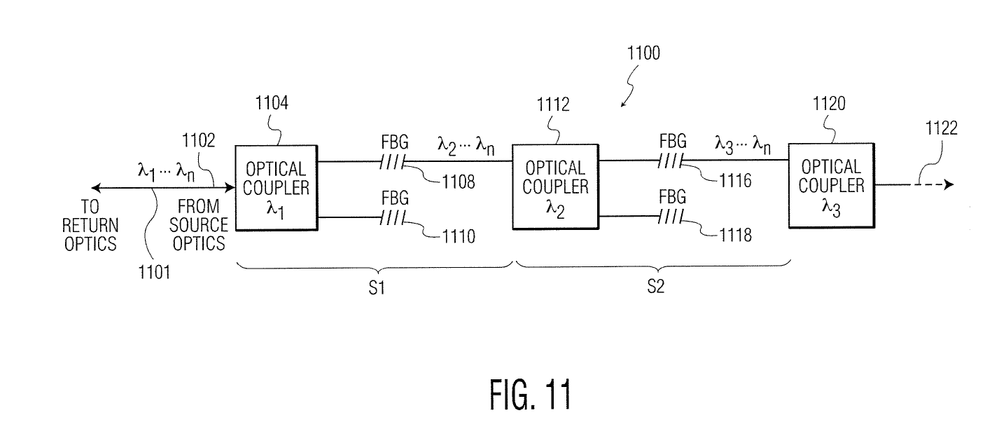

FIG. 10 illustrates an exemplary use of three optical fibers 1002, 1004, and 1006 of a fiber optic cable 1000 in a fiber optic sensing system in accordance with an exemplary embodiment of the present invention. The light source inputs and the sensor outputs are shared among the three optical fibers 1002, 1004, and 1006. For example, optical fiber 1002 carries an input optical signal for wavelengths λ₁ λ₂ λ₃ λ₄, but also an output optical signal for wavelengths λ₉ λ₁₀ λ₁₁ λ₁₂ λ₅ λ₆ λ₇ λ₈. This configuration has the advantage that the optical power is more evenly divided among the optical fibers, and losses associated with OADMs may be more evenly balanced as the drop and add losses are often unequal. In FIG. 10 there are twelve input light source wavelengths and each optical fiber carries four of them. Each of the three fibers carries eight optical return signals. This topology can be extended to “m” optical fibers with an exemplary configuration being that the number of light source wavelengths is a multiple of the number of optical fibers utilized.

FIG. 11 illustrates elements of a fiber optic sensing system 1100 in a Michelson interferometric configuration. An input optical fiber 1102 carries an input optical signal (including “n” wavelengths) transmitted from the source optics of fiber optic sensing system 1100. An optical coupler 1104 divides the optical signal between two fiber legs included in a sensor S1, where sensor S1 includes coupler 1104, a reference leg (including a FBG 1108), and a sensing leg (including a FBG 1110). The optical signal at wavelength 1 (λ₁) reflects back to optical coupler 1104 from each of FBGs 1108, 1110 where the optical signals that are reflected back from FBGs 1108, 1110 are combined coherently to create a time-varying intensity proportional to the time-varying relative phase change between the two fiber legs.

The optical signal carrying the remaining wavelengths (λ₂ . . . λₙ) is next transmitted to an optical coupler 1112. Optical coupler 1112 divides the optical signal between two fiber legs included in a sensor S2, where sensor S2 includes optical coupler 1112, a reference leg (including a FBG 1116), and a sensing leg (including a FBG 1118). The optical signal at wavelength 2 (λ₂) reflects back to optical coupler 1112 where the optical signals that are reflected back from FBGs 1116, 1118 are combined coherently to create a time-varying intensity proportional to the time-varying relative phase change between the two fiber legs (and eventually to optical coupler 1104). The optical signal carrying the remaining wavelengths (λ₃ . . . λₙ) is next transmitted to an optical coupler 1120, and an optical signal 1122 carrying the remaining wavelengths (λ₄ . . . λₙ) is transmitted downstream to subsequent sensors in the optical sensor array. All of the return optical signals from each of the sensors (i.e., sensors S1, S2, etc.) are recombined at optical coupler 1104, and this recombined optical signal 1101 is transmitted along optical fiber 1102 to the return optics for wavelength demultiplexing, interrogation, and analysis.

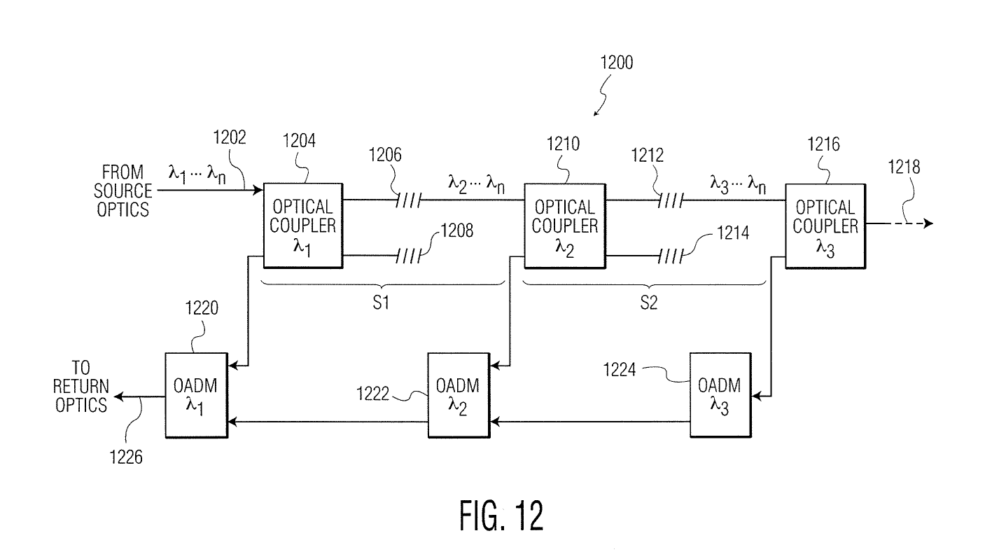

In FIG. 11, the input and return optical signals are transmitted along the same optical fiber. Input and return transmission along the same optical fiber(s) may result in certain undesirable circumstances (e.g., coherent Rayleigh backscatter, etc.). In such a circumstance, it may be desirable to separate the input and return optical signals. FIG. 12 illustrates an example of such a configuration. FIG. 12 illustrates elements of a fiber optic sensing system 1200. An input optical fiber 1202 carries an input optical signal (including “n” wavelengths) transmitted from the source optics of fiber optic sensing system 1200. An optical coupler 1204 divides the optical signal between two fiber legs of a sensor S1 including coupler 1204, a reference leg (including a FBG 1206), and a sensing leg (including a FBG 1208). The optical signal at wavelength 1 (λ₁) reflects back to optical coupler 1204 from each of FBGs 1206, 1208, and then on to an OADM 1220 to be coherently recombined with the optical signal from an OADM 1222.

The optical signal carrying the remaining wavelengths (λ₂ . . . λₙ) is next transmitted to an optical coupler 1210. Optical coupler 1210 divides the optical signal between two fiber legs of sensor S2 including optical coupler 1210, a reference leg (including a FBG 1212), and a sensing leg (including a FBG 1214). The optical signal at wavelength 2 (λ₂) reflects back to optical coupler 1210 (and on to OADM 1222) from each of FBGs 1212, 1214, and then on to OADM 1222 to be coherently recombined with the optical signal from an OADM 1224. The optical signal carrying the remaining wavelengths (λ₃ . . . λₙ) is next transmitted to an optical coupler 1216, and an optical signal 1218 carrying the remaining wavelengths (λ₄ . . . λₙ) is transmitted downstream to subsequent sensors in the optical sensor array. All of the return optical signals from each of the sensors (i.e., sensors S1, S2, etc.) are recombined at respective OADMs, and are eventually recombined at OADM 1220, and this recombined optical signal is transmitted along an optical fiber 1226 to the return optics for wavelength demultiplexing, interrogation, and analysis.

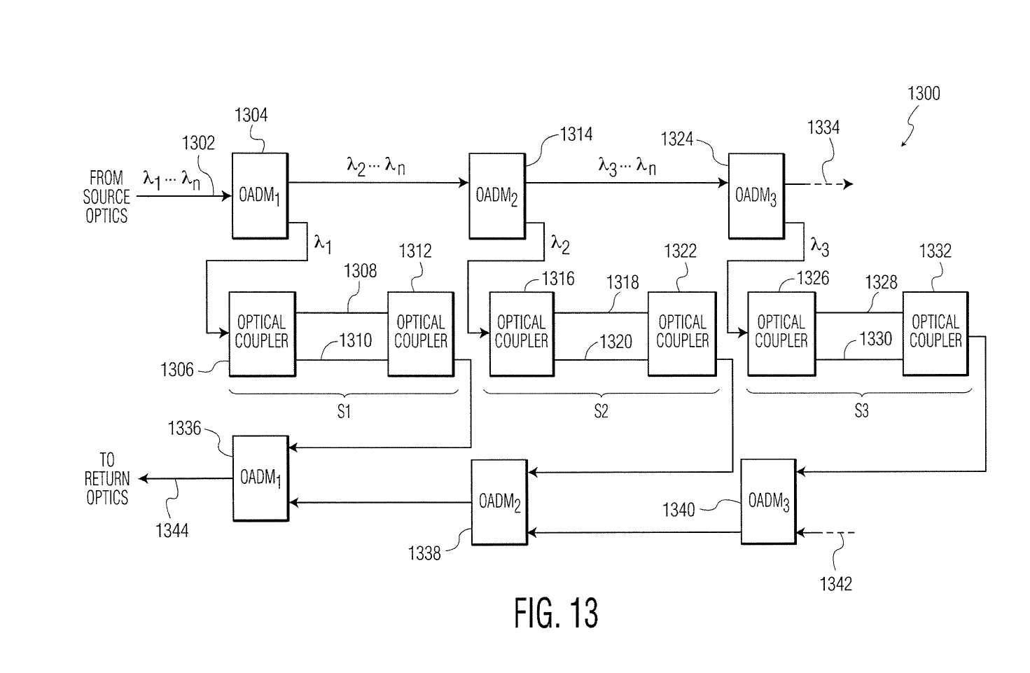

FIG. 13 illustrates elements of a fiber optic sensing system 1300 in a Mach-Zehnder interferometric configuration. An input optical fiber 1302 carries an input optical signal (including “n” wavelengths) transmitted from source optics of fiber optic sensing system 1300. An OADM 1304 (a wavelength tap) strips off wavelength 1 (λ1) for transmission to an optical coupler 1306. Input optical coupler 1306 divides the wavelength 1 optical signal between two fiber legs (i.e., a reference leg 1308 and a sensing leg 1310) included in a sensor S1. The output of sensor S1 is transmitted from its output optical coupler 1312, and then on to an OADM₁ 1336 to be recombined with the return optical signal from an OADM₂ 1338.

The optical signal carrying the remaining wavelengths (λ₂ . . . λₙ) is transmitted to an OADM₂ 1314. OADM₂ 1314 (a wavelength tap) strips off wavelength 2 (λ₂) for transmission to an input optical coupler 1316. Input optical coupler 1316 divides the wavelength 2 optical signal between two fiber legs (i.e., a reference leg 1318 and a sensing leg 1320) included in a sensor S2. The output of sensor S2 is transmitted from its optical coupler 1322, and then on to OADM₂ 1338 to be recombined with the return optical signal from an OADM₃ 1340.

The optical signal carrying the remaining wavelengths (λ₃ . . . λₙ) is next transmitted to an OADM₃ 1324. OADM₃ 1324 (a wavelength tap) strips off wavelength 3 (λ₃) for transmission to an input optical coupler 1326. Input optical coupler 1326 divides the wavelength 3 optical signal between two fiber legs (i.e., a reference leg 1328 and a sensing leg 1330) included in a sensor S3. The output of sensor S3 is transmitted to an optical coupler 1332, and then on to OADM₃ 1340 to be coherently recombined with a return optical signal 1342 (e.g., from downstream OADMs). An optical signal 1334 carrying the remaining wavelengths (λ₄ . . . λₙ) is transmitted downstream to subsequent sensors in the optical sensor array. All of the return optical signals from each of the sensors (i.e., sensors S1, S2, S3, etc.) are eventually recombined at OADM₁ 1336, and this recombined optical signal is transmitted along an optical fiber 1344 to the return optics for wavelength demultiplexing, interrogation, and analysis.

Although the wavelength taps and wavelength combiners utilized in connection with the present invention have largely been described in connection with OADMs, it is understood that different or additional optical elements (e.g., FBGs as wavelength taps, among others) may be utilized.

Although the present invention has particular applicability in high-temperature environments, it is understood that the invention has broad applicability in fiber optic sensing applications.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A fiber optic sensing system comprising:
an optical source adapted to provide an optical signal at a plurality of wavelengths;
a plurality of wavelength taps for separating the optical signal into signal portions at each of the plurality of wavelengths;
a plurality of optical sensors, each of the optical sensors configured to receive one of the signal portions at a respective one of the plurality of wavelengths;
a plurality of wavelength combiners for combining signal portions from the plurality of optical sensors into a recombined signal;
an optical receiver for receiving the recombined signal; and
an optical fiber path between the optical source and the optical receiver.

2. The fiber optic sensing system of claim 1 wherein the signal portions at each of the plurality of wavelengths are narrow line width outputs from the optical source.

3. The fiber optic sensing system of claim 1 wherein each of the optical sensors includes a fiber optic accelerometer.

4. The fiber optic sensing system of claim 1 wherein each of the optical sensors includes an interferometer having a transducer, the interferometer for converting a change in strain of an optical fiber of the optical fiber path into a change in light intensity of the optical signal on the optical fiber.

5. The fiber optic sensing system of claim 1 wherein each of the optical sensors includes a fiber optic accelerometer, the fiber optic accelerometer including a fixed mandrel and a moveable mandrel, wherein an optical fiber of the optical fiber path is wrapped around the fixed mandrel and the moveable mandrel.

6. The fiber optic sensing system of claim 1 wherein each of the optical sensors is a fiber optic hydrophone.

7. The fiber optic sensing system of claim 6 wherein the fiber optic hydrophone is comprised of an optical fiber coated with a voided elastomer.

8. The fiber optic sensing system of claim 1 wherein each of the optical sensors includes a Michelson interferometer.

9. The fiber optic sensing system of claim 1 wherein each of the optical sensors includes a Fabry-Perot interferometer.

10. The fiber optic sensing system of claim 1 wherein each of the optical sensors includes a Fiber Bragg Grating.

11. The fiber optic sensing system of claim 1 wherein each of the optical sensors includes a Sagnac interferometer.

12. The fiber optic sensing system of claim 1 wherein each of the wavelength taps is a wavelength discriminator.

13. The fiber optic sensing system of claim 1 wherein each of the wavelength taps includes an Optical Add/Drop Multiplexer.

14. The fiber optic sensing system of claim 1 wherein each of the wavelength taps includes a wavelength demultiplexer.

15. The fiber optic sensing system of claim 1 wherein each of the wavelength taps includes a slope filter.

16. The fiber optic sensing system of claim 1 wherein each of the wavelength taps includes a Wavelength Division Multiplexer.

17. The fiber optic sensing system of claim 1 wherein each of the wavelength combiners includes at least one of an Optical Add/Drop Multiplexer, a wavelength multiplexer, and a slope filter.

18. A method of operating a fiber optic sensing system, the method comprising the steps of:
(a) transmitting an optical signal from an optical source such that the optical signal includes a plurality of wavelengths;
(b) separating the optical signal into signal portions at each of the plurality of wavelengths using a plurality of wavelength taps;
(c) receiving ones of the signal portions at respective ones of a plurality of optical sensors;
(d) combining signal portions from the plurality of optical sensors into a recombined signal using a plurality of wavelength combiners; and
(e) receiving the recombined signal at an optical receiver.

19. The method of claim 18 wherein step (c) further comprises a step of converting a physical quantity to an optical phase change within an optical fiber included in a respective one of the plurality of optical sensors.

20. The method of claim 19 wherein the physical quantity includes at least one of acceleration and pressure.

21. The method of claim 19 wherein step (c) further comprises the step of converting the optical phase change within the optical fiber to an optical intensity change by use of an interferometer.

22. The method of claim 19 further comprising the step of converting a portion of the recombined signal to an electrical output proportional to the converted physical quantity.

23. The method of claim 18 further comprising the step of demultiplexing the recombined signal.

24. The method of claim 18 further comprising the step of interrogating the recombined signal.

25. The method of claim 18 wherein step (b) includes using optical add/drop multiplexers as the plurality of wavelength taps.

26. The method of claim 18 wherein each of the wavelength taps includes at least one of a wavelength discriminator, a wavelength demultiplexer, and a slope filter.

27. The method of claim 18 wherein each of the wavelength combiners includes at least one of an optical add/drop multiplexer, a wavelength multiplexer, and a slope filter.

28. The method of claim 18 wherein each of the plurality of optical sensors includes a fiber optic accelerometer.

29. The method of claim 18 wherein each of the optical sensors includes a transducer for converting a change in strain of an optical fiber within the respective optical sensor into a change in light intensity of the optical signal on the optical fiber.

30. The method of claim 18 wherein each of the plurality of optical sensors includes a fiber optic accelerometer, the fiber optic accelerometer including a fixed mandrel and a moveable mandrel, wherein an optical fiber within the respective optical sensor is wrapped around the fixed mandrel and the moveable mandrel.

31. The method of claim 18 wherein each of the optical sensors includes at least one of a Michelson interferometer, a Fabry-Perot interferometer, a fiber Bragg grating, and a Sagnac interferometer.
